(19) United States
(12) Patent Application Publication
(10) Pub. No.: US 2024/0161690 A1
(43) Pub. Date: May 16, 2024

(54) DISPLAY PANEL AND DISPLAY DEVICE

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Zheng Shen, Shenzhen, Guangdong (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 17/756,652

(22) PCT Filed: Apr. 14, 2022
(86) PCT No.: PCT/CN2022/086884

§ 371 Date: May 29, 2022

(30) Foreign Application Priority Data
Apr. 1, 2022 (CN) 202210347158.0

(51) Int. Cl. G09G 3/3233; G09G 3/32

(52) U.S. Cl. CPC G09G 3/3233; G09G 3/32; G09G 2300/0842; G09G 2320/0209

(57) ABSTRACT

Embodiments of the present disclosure are directed to a display panel and a display device. The display panel includes a plurality of pixel units arranged in an array. The pixel units comprise a driving circuit. The driving circuit includes a light emitting device, a driving transistor, a write-in compensation module, a current detecting module, and a light emitting control module. This could solve the display abnormalities resulted from different cross voltages of the light emitting device in pixels of the same row of the conventional display panel.

### FIELD OF THE DISCLOSURE

The present disclosure relates to a display technology, and more particularly, to a display panel and a display device.

### BACKGROUND

The organic light emitting diode (OLED) is an active light emitting device. Compared with the liquid crystal display (LCD), the OLED display does not need the backlight module. Furthermore, OLED display has advantages, including a thinner panel, high luminance and low driving voltage, and thus is regarded as a next-generation display.

In a conventional large-size OLED display, when pixels of the same row are scanned, the write-in control signal and the reading control signal are turned on at the same time. Then, different data voltages and the detection voltage are inputted to control the degree of turning on the driving transistor such that the current passing through the OLED is controlled to display different luminance. Here, the adjacent pixels are connected to the same detection signal line, which means the same detection voltage is applied on these pixels.

Because the current-voltage characteristic of the OLED device is not a characteristic of an ideal diode. The cross-voltage slightly increases as the increase of the current (luminance increase). In this way, the write-in control signal and the reading control signal are simultaneously turned on and there may be some errors when the data signal and the detection signal are written into the display. The errors are introduced because the cross voltage of the diode of a higher luminance becomes higher such that the voltage of the detection end is higher. In this way, when the pixels of the same row are being turned on to write in the detection voltage, the pixels having a higher detection voltage may divide its voltage to the pixels having a lower detection voltage such that the cross voltage of data voltage-detection voltage has distortions, which result in the distortions of the gray voltage. Accordingly, display abnormalities, such as lateral crosstalk, may occur.

### SUMMARY

### Technical Problem

One objective of an embodiment of the present disclosure is to provide a display panel and a display device. By breaking the electrical connection of the light emitting device when the pixel voltage is being written in, the display abnormalities resulted from different cross voltages of the light emitting devices in pixels of the same row of the conventional display panel could be improved.

### Technical Solution

According to an embodiment of the present disclosure, a display panel is disclosed. The display panel comprises a plurality of pixel units arranged in an array. The pixel units comprise a driving circuit. The driving circuit includes a light emitting device, a driving transistor, a write-in compensation module, a current detecting module, and a light emitting control module. The light emitting device is connected in series with a light emitting circuit. The driving transistor has a source and a drain connected in series of the light emitting circuit and a gate electrically connected to the first node. The write-in compensation module receives a data signal and a scan signal and electrically connected to a first node and a second node, and transfers the data signal to the first node under a control of the scan signal. The current detecting module receives a first control signal and a detection signal and electrically connected to the second node, and is configured to detect an actual current passing through the driving transistor and compare the actual current with a predetermined current to generate a compensation voltage of the driving transistor and further configured to perform a compensation on the driving transistor according to the compensation voltage. The light emitting control module receives the second control signal and connected in series with the light emitting circuit, and is configured to establish/break an electrical connection between the second node and the light emitting device under a control of the second control signal.

Optionally, the write-in compensation module comprises a first transistor and a storage capacitor. The first transistor has a gate receiving the scan signal, a first electrode receiving the data signal, and a second electrode electrically connected to the first node. The storage capacitor is electrically connected between the first node and the second node.

Optionally, the current detecting module comprises a second transistor, having a gate receiving the first control signal, a first electrode receiving the detection signal, and a second electrode electrically connected to the second node.

Optionally, the light emitting control module comprises a third transistor, having a gate receiving the second control signal, a first electrode connected to the second node, and a second electrode electrically connected to an anode of the light emitting device.

Optionally, the scan signal, the first control signal and the second control signal are identical.

Optionally, the driving transistor, the first transistor and the second transistor are N-type transistors, and the third transistor is a P-type transistor.

Optionally, the first transistor and the second transistor are P-type transistors, and the third transistor and the driving transistor are N-type transistors.

Optionally, the light emitting control module further comprises an inverter, having an input end receiving the scan signal and an output end electrically connected to the gate of the third transistor.

Optionally, the driving transistor, the first transistor, the second transistor and the third transistor are a same type of transistors.

Optionally, the scan signal, the first control signal and the second control signal are used to control the display panel to operate in a data write-in phase and a light emitting phase.

According to another embodiment of the present disclosure, a display device is disclosed. The display device comprises a driving chip and a display panel. The driving chip is electrically connected to the display panel. The display panel comprises a plurality of pixel units arranged in an array. The pixel units comprise a driving circuit. The driving circuit includes a light emitting device, a driving transistor, a write-in compensation module, a current detecting module, and a light emitting control module. The light emitting device is connected in series with a light emitting circuit. The driving transistor has a source and a drain connected in series of the light emitting circuit and a gate electrically connected to the first node. The write-in compensation module receives a data signal and a scan signal and electrically connected to a first node and a second node, and transfers the data signal to the first node under a control of the scan signal. The current detecting module receives a first control signal and a detection signal and electrically connected to the second node, and is configured to detect an actual current passing through the driving transistor and compare the actual current with a predetermined current to generate a compensation voltage of the driving transistor and further configured to perform a compensation on the driving transistor according to the compensation voltage. The light emitting control module receives the second control signal and connected in series with the light emitting circuit, and is configured to establish/break an electrical connection between the second node and the light emitting device under a control of the second control signal.

Optionally, the write-in compensation module comprises a first transistor and a storage capacitor. The first transistor has a gate receiving the scan signal, a first electrode receiving the data signal, and a second electrode electrically connected to the first node. The storage capacitor is electrically connected between the first node and the second node.

Optionally, the current detecting module comprises a second transistor, having a gate receiving the first control signal, a first electrode receiving the detection signal, and a second electrode electrically connected to the second node.

Optionally, the light emitting control module comprises a third transistor, having a gate receiving the second control signal, a first electrode connected to the second node, and a second electrode electrically connected to an anode of the light emitting device.

Optionally, the scan signal, the first control signal and the second control signal are identical.

Optionally, the driving transistor, the first transistor and the second transistor are N-type transistors, and the third transistor is a P-type transistor.

Optionally, the first transistor and the second transistor are P-type transistors, and the third transistor and the driving transistor are N-type transistors.

Optionally, the light emitting control module further comprises an inverter, having an input end receiving the scan signal and an output end electrically connected to the gate of the third transistor.

Optionally, the driving transistor, the first transistor, the second transistor and the third transistor are a same type of transistors.

Optionally, the scan signal, the first control signal and the second control signal are used to control the display panel to operate in a data write-in phase and a light emitting phase.

### Advantageous Effect

The present disclosure discloses a display panel and a display device. The display panel comprises a plurality of pixel units arranged in an array. The pixel units comprise a driving circuit. The driving circuit includes a light emitting device, a driving transistor, a write-in compensation module, a current detecting module, and a light emitting control module. The light emitting device is connected in series with a light emitting circuit. The driving transistor has a source and a drain connected in series of the light emitting circuit and a gate electrically connected to the first node. The write-in compensation module receives a data signal and a scan signal and electrically connected to a first node and a second node, and transfers the data signal to the first node under a control of the scan signal. The current detecting module receives a first control signal and a detection signal and electrically connected to the second node, and is configured to detect an actual current passing through the driving transistor and compare the actual current with a predetermined current to generate a compensation voltage of the driving transistor and further configured to perform a compensation on the driving transistor according to the compensation voltage. The light emitting control module receives the second control signal and connected in series with the light emitting circuit, and is configured to establish/break an electrical connection between the second node and the light emitting device under a control of the second control signal. By breaking the electrical connection of the light emitting device when the pixel voltage is being written in, the display abnormalities resulted from different cross voltages of the light emitting device in pixels of the same row of the conventional display panel.

### BRIEF DESCRIPTION OF THE DRAWINGS

To describe the technical solutions in the embodiments of this application more clearly, the following briefly introduces the accompanying drawings required for describing the embodiments. Apparently, the accompanying drawings in the following description show merely some embodiments of this application, and a person of ordinary skill in the art may still derive other drawings from these accompanying drawings without creative efforts.

FIG. 1 is a diagram of a display panel according to an embodiment of the present disclosure.

FIG. 2 is a functional diagram of a driving circuit according to an embodiment of the present disclosure.

FIG. 3 is a circuit diagram of a driving circuit of a display panel according to a first embodiment of the present disclosure.

FIG. 4 is a timing diagram of the driving circuit of the display panel according to the first embodiment of the present disclosure.

FIG. 5 is a circuit diagram of a driving circuit of a display panel according to a second embodiment of the present disclosure.

FIG. 6 is a circuit diagram of a driving circuit of a display panel according to a third embodiment of the present disclosure.

FIG. 7 is a circuit diagram of a driving circuit of a display panel according to a fourth embodiment of the present disclosure.

FIG. 8 is a timing diagram of the driving circuit of the display panel according to the fourth embodiment of the present disclosure.

FIG. 9 is a diagram of a backlight module according to an embodiment of the present disclosure.

FIG. 10 is a functional block diagram of a display device according to an embodiment of the present disclosure.

### DETAILED DESCRIPTION

To help a person skilled in the art better understand the solutions of the present disclosure, the following clearly and completely describes the technical solutions in the embodiments of the present disclosure with reference to the accompanying drawings in the embodiments of the present disclosure. Apparently, the described embodiments are a part rather than all of the embodiments of the present disclosure. All other embodiments obtained by a person of ordinary skill in the art based on the embodiments of the present disclosure without creative efforts shall fall within the protection scope of the present disclosure.

The embodiments of the present disclosure provide a display panel and a display device, which can solve the display abnormality problem caused by the partial voltage caused by the difference across voltages of light-emitting devices between pixels in the same row of the existing display panel. Each of them will be described in detail below. It should be noted that the description order of the following embodiments is not intended to limit the preferred order of the embodiments. In addition, in the description of this application, the term “including” means “including but not limited to”. The terms “first,” “second,” “third,” etc. are used merely as labels to distinguish between different objects, rather than to describe a particular order.

In the following disclosure, the transistors could be thin film transistors (TFTs), field effect transistors (FETs) or any other devices having similar characteristics. Because the source and drain of the transistors are symmetric, the source and drain could be switched. In the following embodiments, in order to distinguish the electrodes other than the gate in the transistor, if the first electrode is a source/drain, then the second electrode is a drain/source. In the configurations shown in the figures, the middle end of the switch transistor is the gate, the signal input end is the source and the output end is the drain. Furthermore, the transistors in the following embodiments could be N-type transistors or P-type transistors. The N-type transistor is turned on when a high voltage level is applied on the gate and is turned off when a low voltage level is applied on the gate. The P-type transistor is turned on when a low voltage is applied on the gate and is turned off when a high voltage level is applied on the gate. In the following embodiments, the light emitting device D could be a mini light emitting diode (Mini LED), a micro light emitting diode (Micro LED) or an organic light emitting diode (OLED).

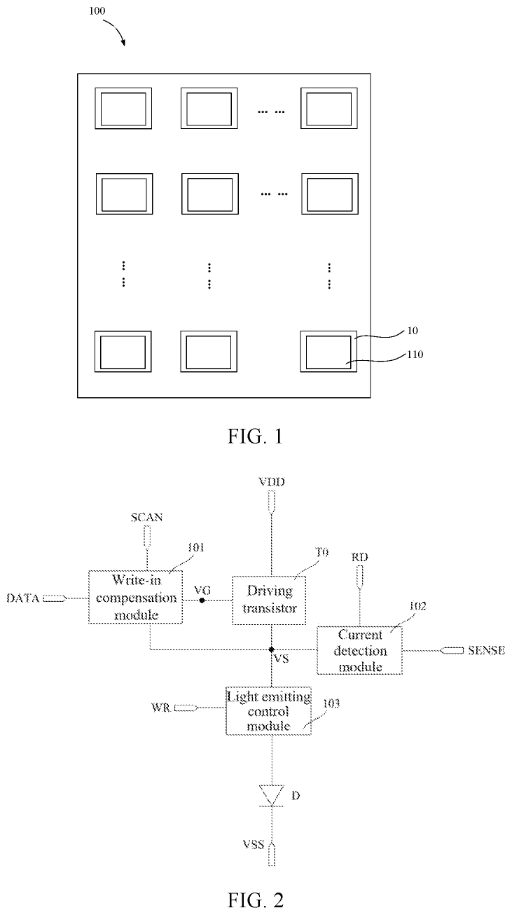

Please refer to FIG. 1 and FIG. 2. FIG. 1 is a diagram of a display panel according to an embodiment of the present disclosure. FIG. 2 is a functional diagram of a driving circuit according to an embodiment of the present disclosure. The display panel 100 comprises a plurality of pixel units 110. The pixel units 110 comprise a driving circuit 10. The driving circuit 10 comprises a light emitting device D, a driving transistor T0, a write-in compensation module 101, a current detection module 102 and a light emitting control module 103.

The light emitting device D is connected in series with a light emitting circuit including the first power end VDD and the second power end VSS. The source of the driving transistor T0 is electrically connected to the first power end VDD. The drain of the driving transistor T0 is electrically connected to the second node VS. The gate of the driving transistor T0 is electrically connected to the first node VG. The write-in compensation module receives the data signal DATA and the scan signal SCAN and is electrically connected to the first node VG and the second node VS. The write-in compensation module transfers the data signal DATA to the first node VG under the control of the scan signal SCAN. The current detection module receives the first control signal RD and the detection signal SENSE and is electrically connected to the second node VS. The current detection module is configured to detect the actual current passing through the driving transistor TO and compare the actual current with the predetermined current to generate a compensation voltage of the driving transistor T0. Here, the write-in compensation module is further configured to perform a compensation on the threshold voltage of the driving transistor TO according to the compensation voltage. The light emitting control module receives the second control signal WR and is connected in series with the light emitting circuit. The light emitting control module is configured to establish or break the electrical connection between the second node VS and the light emitting device D under the control of the second control signal WR.

The scan signal SCAN, the first control signal RD and the second control signal WR could be different signals. Preferably, the scan signal SCAN, the first control signal RD and the second control signal WR could be the same signal. This could simplify the circuit and reduce the cost to improve the product competitiveness.

The display panel of the present disclosure utilizes the current detection module to detect the actual current passing through the driving transistor T0 and compare the actual current with the predetermined current to generate the compensation voltage of the driving transistor T0. The write-in compensation module compensates the threshold voltage of the driving transistor T0 according to the compensation voltage. The light emitting control module establishes or breaks the electrical connection between the second node VS and the light emitting device D under the control of the second control signal WR. Here, during the process of writing the pixel voltage to break the connection of the light emitting device D, the display abnormalities resulted from different cross voltages of the light emitting devices in pixels of the same row of the conventional display panel could be improved.

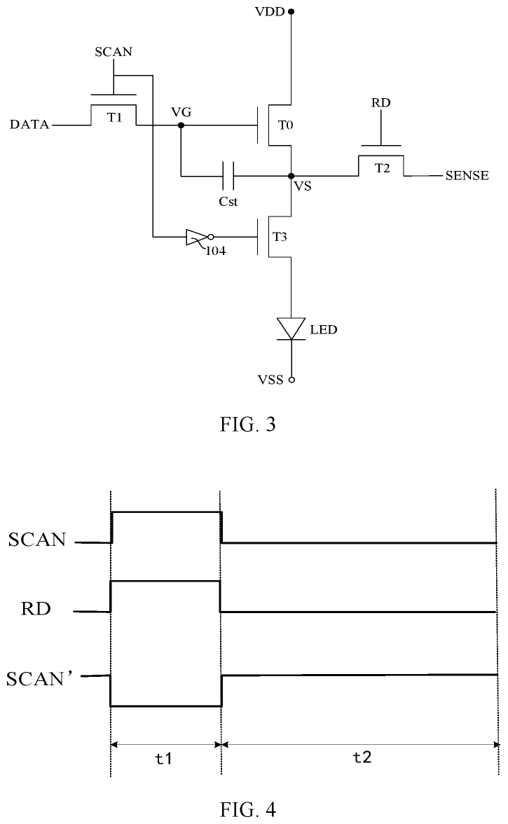

Please refer to FIG. 1, FIG. 3 and FIG. 4. FIG. 3 is a circuit diagram of a driving circuit of a display panel according to a first embodiment of the present disclosure. FIG. 4 is a timing diagram of the driving circuit of the display panel according to the first embodiment of the present disclosure. The display panel 100 comprises a plurality of pixel units 110. The pixel units 110 comprise a driving circuit 10. The driving circuit 10 comprises a light emitting device D, a driving transistor T0, a first transistor T1, a storage capacitor Cst, a second transistor T2 and a third transistor T3. In this embodiment, the driving transistor T0 is configured to control the current passing through the driving circuit 10. The source of the driving transistor T0 is electrically connected to the first power end VDD. The drain of the driving transistor T0 is electrically connected to the second node VS. The gate of the driving transistor T0 is electrically connected to the first node VG. The gate of the first transistor T1 receives the scan signal SCAN. The source of the first transistor T1 receives the data signal DATA. The drain of the first transistor T1 is electrically connected to the first node VG. The first end of the storage capacitor Cst is electrically connected to the first node VG. The second end of the storage capacitor Cst is electrically connected to the second node VS. The storage capacitor Cst is a gate voltage maintaining capacitor of the driving transistor T0. The gate of the second transistor T2 receives the first control signal RD. The source of the second transistor T2 receives the detection signal SENSE. The drain of the second transistor T2 is electrically connected to the second node VS. The gate of the third transistor T3 receives the scan signal SCAN. The source of the third transistor T3 is electrically connected to the second node VS. The drain of the third transistor T3 is electrically connected to the anode of the light emitting device D. The cathode of the light emitting device D is electrically connected to the second power end VSS.

Each of the first power end VDD and the second power end VSS is configured to output a predetermined voltage. In addition, in this embodiment, the voltage level of the first voltage end VDD is larger than the voltage level of the second voltage end VSS. Specifically, the voltage level of the second voltage end VSS could be a ground voltage. Surely, the voltage level of the second voltage end VSS could be another voltage level.

The driving circuit 10 further comprises an inverter 104. The input end of the inverter 104 receives the scan signal SCAN. The output end of the inverter 104 is electrically connected to the gate of the third transistor T3.

The driving transistor T0, the first transistor T1, the second transistor T2 and the third transistor T3 are the same type of transistors. Specifically, the driving transistor T0, the first transistor T1, the second transistor T2 and the third transistor T3 are all N-type transistors or N-type transistors.

The driving transistor T0, the first transistor T1, the second transistor T2 and the third transistor T3 could be one or more of low temperature poly-silicon thin film transistors (TFTs), oxide semiconductor TFTs or amorphous TFTs, and field effect transistors.

The driving circuit 10 places the inverter between the gate of the first transistor T1 and the gate of the third transistor T3. The input end of the inverter 104 receives the scan signal SCAN at the gate of the first transistor T1. The output end of the inverter 104 is electrically connected to the gate of the third transistor T3 to turn on or turn off the third transistor T3 under the control of the scan signal SCAN. Here, when the pixel voltage is being written, the third transistor T3 is turned off. That is, the current does not pass through the light emitting device D such that the display abnormalities resulted from different cross voltages of the light emitting devices D in pixels of the same row of the conventional display panel.

As shown in FIG. 4, the scan signal SCAN, the first control signal RD and the scan signal SCAN′ generated by the inverter 104 work together such that the display panel is controlled to operate in the data write-in phase t1 and the light emitting phase t2. That is, in a frame period, the driving control timing sequence of the driving circuit 10 comprises the data write-in phase t1 and the light emitting phase t2. Please note, the light emitting device D generates light in the light emitting phase t2.

As shown in FIG. 3 and FIG. 4, in the data write-in phase t1, the scan signal SCAN corresponds to a high voltage level, the scan signal SCAN′ corresponds to a low voltage level and the first control signal RD corresponds to a high voltage level.

The first transistor T1 is turned on under the control of the high voltage level of the scan signal SCAN. The second transistor T2 is turned on under the control of the high voltage level of the first control signal RD such that the detection signal SENSE is transferred to the second node VS to detect the actual current passing through the driving transistor T0 and the actual current is compared with the predetermined current to generate the compensation voltage of the driving transistor T0.

Furthermore, under the effect of the inverter 104, the scan signal SCAN′ received by the third transistor T3 corresponds to a low voltage level. Accordingly, the third transistor is turned off under the control of the scan signal SCAN′.

In the light emitting phase t2, the scan signal SCAN corresponds to a low voltage level, the first control signal RD corresponds to a low voltage level and the scan signal SCAN′ corresponds to a high voltage level.

The first power end VDD and the second power end VSS are both direct current (DC) voltage sources.

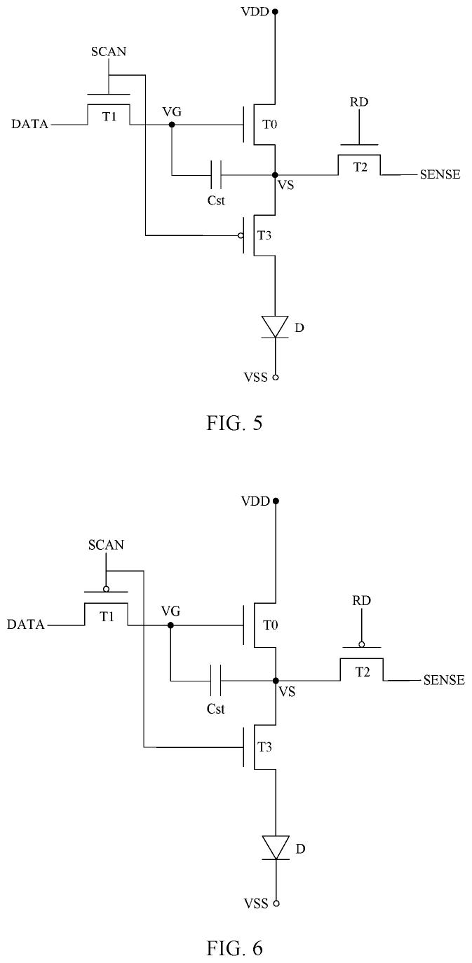

In an embodiment, please refer to FIG. 1 and FIG. 5. FIG. 5 is a circuit diagram of a driving circuit of a display panel according to a second embodiment of the present disclosure. As shown in FIG. 5, the third transistor T3 is a P-type transistor and the first transistor T1, the driving transistor T0 and the second transistor T2 are all N-type transistors. Because the P-type transistor in this embodiment has a similar effect of the inverter 104, the timings of this embodiment are similar to the timings of the previous embodiment.

As shown in FIG. 1 and FIG. 5, the display panel 100 of this embodiment comprises a plurality of pixel units 110 arranged in an array. The pixel units 110 comprise a driving circuit 10. The driving circuit 10 comprises: a light emitting device D, a driving transistor T0, a first transistor T1, a storage capacitor Cst, a second transistor T2 and a third transistor T3. In this embodiment, the driving transistor T0 is configured to control the current passing through the driving circuit 10. The source of the driving transistor T0 is electrically connected to the first power end VDD. The drain of the driving transistor T0 is electrically connected to the second node VS. The gate of the driving transistor T0 is electrically connected to the first node VG. The gate of the first transistor T1 receives the scan signal SCAN. The source of the first transistor T1 receives the data signal DATA. The drain of the first transistor T1 is electrically connected to the first node VG. The first end of the storage capacitor Cst is electrically connected to the first node VG. The second end of the storage capacitor Cst is electrically connected to the second node VS. The storage capacitor Cst is a gate voltage maintaining capacitor of the driving transistor T0. The gate of the second transistor T2 receives the first control signal RD. The source of the second transistor T2 receives the detection signal SENSE. The drain of the second transistor T2 is electrically connected to the second node VS. The gate of the third transistor T3 receives the scan signal SCAN. The source of the third transistor T3 is electrically connected to the second node VS. The drain of the third transistor T3 is electrically connected to the anode of the light emitting device D. The cathode of the light emitting devices D is electrically connected to the second power end VSS.

The display panel 100 of this embodiment utilizes a P-type transistor as the third transistor T3. When the scan signal SCAN corresponds to a high voltage level, the scan signal SCAN turns off the third transistor T3. When the scan signal SCAN corresponds to a low voltage level, the scan signal SCAN turns on the third transistor T3. When the pixel voltage is being written, the third transistor T3 is turned off. That is, the current does not pass through the light emitting device D such that the display abnormalities resulted from different cross voltages of the light emitting devices D in pixels of the same row of the conventional display panel.

Please refer to FIG. 1 and FIG. 6. FIG. 6 is a circuit diagram of a driving circuit of a display panel according to a third embodiment of the present disclosure.

The display panel 100 of this embodiment comprises a plurality of pixel units 110 arranged in an array. The pixel units 110 comprise a driving circuit 10. The driving circuit 10 comprises: a light emitting device D, a driving transistor T0, a first transistor T1, a storage capacitor Cst, a second transistor T2 and a third transistor T3. The first transistor T1 and the second transistor T2 are P-type transistors. The third transistor T3 and the driving transistor TO are N-type transistors. In this embodiment, the driving transistor T0 is configured to control the current passing through the driving circuit 10. The source of the driving transistor TO is electrically connected to the first power end VDD. The drain of the driving transistor TO is electrically connected to the second node VS. The gate of the driving transistor T0 is electrically connected to the first node VG. The gate of the first transistor T1 receives the scan signal SCAN. The source of the first transistor T1 receives the data signal DATA. The drain of the first transistor T1 is electrically connected to the first node VG. The first end of the storage capacitor Cst is electrically connected to the first node VG. The second end of the storage capacitor Cst is electrically connected to the second node VS. The storage capacitor Cst is a gate voltage maintaining capacitor of the driving transistor T0. The gate of the second transistor T2 receives the first control signal RD. The source of the second transistor T2 receives the detection signal SENSE. The drain of the second transistor T2 is electrically connected to the second node VS. The gate of the third transistor T3 receives the scan signal SCAN. The source of the third transistor T3 is electrically connected to the second node VS. The drain of the third transistor T3 is electrically connected to the anode of the light emitting device D. The cathode of the light emitting device D is electrically connected to the second power end VSS.

The display panel 100 of this embodiment utilizes P-type transistors as the first transistor T1 and the second transistor T2 and utilizes N-type transistors as the third transistor T3 and the driving transistor T0. When the pixel voltage is being written, the third transistor T3 is turned off. That is, the current does not pass through the light emitting device D such that the display abnormalities resulted from different cross voltages of the light emitting devices D in pixels of the same row of the conventional display panel.

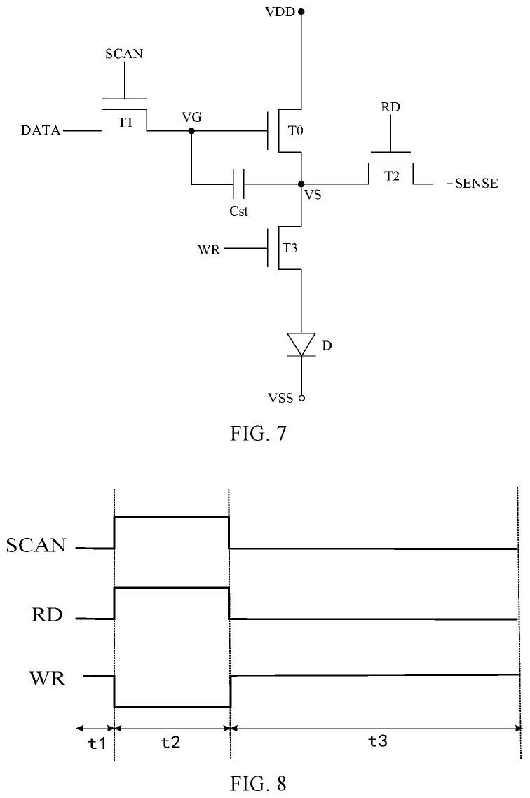

Please refer to FIG. 1, FIG. 7 and FIG. 8. FIG. 7 is a circuit diagram of a driving circuit of a display panel according to a fourth embodiment of the present disclosure. FIG. 8 is a timing diagram of the driving circuit of the display panel according to the fourth embodiment of the present disclosure.

The display panel 100 of this embodiment comprises a plurality of pixel units 110 arranged in an array. The pixel units 110 comprise a driving circuit 10. The driving circuit 10 comprises: a light emitting device D, a driving transistor T0, a first transistor T1, a storage capacitor Cst, a second transistor T2 and a third transistor T3. As shown in FIG. 7, the gate of the third transistor T3 receives the second control signal WR. The driving transistor T0, the first transistor T1, the second transistor T2 and the third transistor T3 are all the same type of transistors. Specifically, the driving transistor T0, the first transistor T1, the second transistor T2 and the third transistor T3 are all N-type transistors or P-type transistors. In this embodiment, the driving transistor T0 is configured to control the current passing through the driving circuit 10. The source of the driving transistor T0 is electrically connected to the first power end VDD. The drain of the driving transistor T0 is electrically connected to the second node VS. The gate of the driving transistor T0 is electrically connected to the first node VG. The gate of the first transistor T1 receives the scan signal SCAN. The source of the first transistor T1 receives the data signal DATA. The drain of the first transistor T1 is electrically connected to the first node VG. The first end of the storage capacitor Cst is electrically connected to the first node VG. The second end of the storage capacitor Cst is electrically connected to the second node VS. The storage capacitor Cst is a gate voltage maintaining capacitor of the driving transistor T0. The gate of the second transistor T2 receives the first control signal RD. The source of the second transistor T2 receives the detection signal SENSE. The drain of the second transistor T2 is electrically connected to the second node VS. The gate of the third transistor T3 receives the scan signal SCAN. The source of the third transistor T3 is electrically connected to the second node VS. The drain of the third transistor T3 is electrically connected to the anode of the light emitting device D. The cathode of the light emitting device D is electrically connected to the second power end VSS.

As shown in FIG. 8, in the data write-in phase t1, the scan signal SCAN corresponds to a high voltage level, the second control signal WR corresponds to a low voltage level, and the first control signal RD corresponds to a high voltage level.

The first transistor T1 is turned on under the control of the high voltage level of the scan signal SCAN. The second transistor T2 is turned on under the control of the high voltage level of the first control signal RD to transfer the detection signal SENSE to the second node VS such that the actual current passing through the driving transistor T0 is detected and compared with the predetermined current to generate a compensation voltage of the driving transistor T0.

The third transistor T3 is turned off under the low voltage level of the second control signal WR.

In the light emitting phase t2, the scan signal SCAN corresponds to a low voltage level, the first control signal RD corresponds to a low voltage level, and the second control signal WR corresponds to a high voltage level.

Specifically, the first power end VDD and the second power end VSS are both DC voltage sources.

The display panel 100 of this embodiment utilizes the gate of the third transistor T3 to receive the second control signal WR and the driving transistor T0, the first transistor T1, the second transistor T2 and the third transistor T3 are all the same type of transistors. When the pixel voltage is being written, the third transistor T3 is turned off. That is, the current does not pass through the light emitting device D such that the display abnormalities resulted from different cross voltages of the light emitting devices D in pixels of the same row of the conventional display panel.

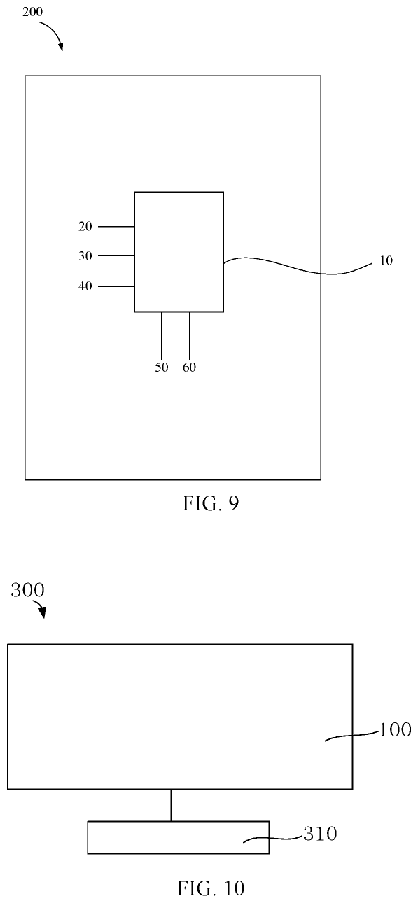

Please refer to FIG. 9. FIG. 9 is a diagram of a backlight module according to an embodiment of the present disclosure. According to an embodiment of the present disclosure, a backlight module 200 is disclosed. The backlight module 200 comprises a data line 20, a first control signal RD line 30, a second control signal WR line 40, a scan line 50, a detection line 60 and the above-mentioned driving circuit 10. In this embodiment, the data line 20 is configured to provide the data signal DATA. The first control signal RD line 30 is configured to provide the first control signal RD. The second control signal WR line 40 is configured to provide the second control signal WR. The detection line 60 is configured to provide the detection signal SENSE. The scan line 50 is configured to provide the scan signal SCAN. The driving circuit 10 is electrically connected to the data line 20, the first control signal RD line 30, the second control signal WR line 40, the scan line 50, and the detection line 60. Here, the light emitting device D could be a Mini-LED or a Micro-LED. The operations of the driving circuit 10 could be referred to the above descriptions of the driving circuit 10 and further illustration is omitted here.

Please refer to FIG. 10. FIG. 10 is a functional block diagram of a display device according to an embodiment of the present disclosure. The display device 300 comprises a driving chip 310 and a display panel 100. The driving chip 310 is electrically connected to the display panel 100.

The display panel could be an electronic paper, a cell phone, a tablet, a television, a display, a laptop, a digital picture frame, a navigator, or any other product or device having a display function.

The embodiments of the present disclosure directed to a display panel and a display device have been described in detail above, and the principles and implementations of the present disclosure are described with specific examples. The descriptions of the above embodiments are only used to help understand the present disclosure. At the same time, for those skilled in the art, according to the idea of the present disclosure, there will be changes in the specific implementation and application scope. In conclusion, the contents of this specification should not be construed as a limit.

What is claimed is:

1. A display panel, comprising a plurality of pixel units arranged in an array, the pixel units comprising a driving circuit, and the driving circuit comprising:
a light emitting device, connected in series with a light emitting circuit;
a driving transistor, having a source and a drain connected in series of the light emitting circuit and a gate electrically connected to the first node;
a write-in compensation module, receiving a data signal and a scan signal and electrically connected to a first node and a second node, configured to transfer the data signal to the first node under a control of the scan signal;
a current detecting module, receiving a first control signal and a detection signal and electrically connected to the second node, configured to detect an actual current passing through the driving transistor and compare the actual current with a predetermined current to generate a compensation voltage of the driving transistor and further configured to perform a compensation on the driving transistor according to the compensation voltage; and
a light emitting control module, receiving the second control signal and connected in series with the light emitting circuit, configured to establish/break an electrical connection between the second node and the light emitting device under a control of the second control signal.

2. The display panel of claim 1, wherein the write-in compensation module comprises:
a first transistor, having a gate receiving the scan signal, a first electrode receiving the data signal, and a second electrode electrically connected to the first node; and
a storage capacitor, electrically connected between the first node and the second node.

3. The display panel of claim 2, wherein the current detecting module comprises:
a second transistor, having a gate receiving the first control signal, a first electrode receiving the detection signal, and a second electrode electrically connected to the second node.

4. The display panel of claim 3, wherein the light emitting control module comprises:
a third transistor, having a gate receiving the second control signal, a first electrode connected to the second node, and a second electrode electrically connected to an anode of the light emitting device.

5. The display panel of claim 4, wherein the scan signal, the first control signal and the second control signal are identical.

6. The display panel of claim 5, wherein the driving transistor, the first transistor and the second transistor are N-type transistors, and the third transistor is a P-type transistor.

7. The display panel of claim 5, wherein the first transistor and the second transistor are P-type transistors, and the third transistor and the driving transistor are N-type transistors.

8. The display panel of claim 5, wherein the light emitting control module further comprises an inverter, having an input end receiving the scan signal and an output end electrically connected to the gate of the third transistor.

9. The display panel of claim 8, wherein the driving transistor, the first transistor, the second transistor and the third transistor are a same type of transistors.

10. The display panel of claim 1, wherein the scan signal, the first control signal and the second control signal are used to control the display panel to operate in a data write-in phase and a light emitting phase.

11. A display device, comprising:
a driving chip; and
a display panel, electrically connected to the driving chip, the display panel, comprising a plurality of pixel units arranged in an array, the pixel unit comprising a driving circuit, and the driving circuit comprising:
a light emitting device, connected in series with a light emitting circuit;
a driving transistor, having a source and a drain connected in series of the light emitting circuit and a gate electrically connected to the first node;
a write-in compensation module, receiving a data signal and a scan signal and electrically connected to a first node and a second node, configured to transfer the data signal to the first node under a control of the scan signal;
a current detecting module, receiving a first control signal and a detection signal and electrically connected to the second node, configured to detect an actual current passing through the driving transistor and compare the actual current with a predetermined current to generate a compensation voltage of the driving transistor and further configured to perform a compensation on the driving transistor according to the compensation voltage; and
a light emitting control module, receiving the second control signal and connected in series with the light emitting circuit, configured to establish/break an electrical connection between the second node and the light emitting device under a control of the second control signal.

12. The display device of claim 11, wherein the write-in compensation module comprises:
a first transistor, having a gate receiving the scan signal, a first electrode receiving the data signal, and a second electrode electrically connected to the first node; and
a storage capacitor, electrically connected between the first node and the second node.

13. The display device of claim 12, wherein the current detecting module comprises:
a second transistor, having a gate receiving the first control signal, a first electrode receiving the detection signal, and a second electrode electrically connected to the second node.

14. The display device of claim 13, wherein the light emitting control module comprises:
a third transistor, having a gate receiving the second control signal, a first electrode connected to the second node, and a second electrode electrically connected to an anode of the light emitting device.

15. The display device of claim 14, wherein the scan signal, the first control signal and the second control signal are identical.

16. The display device of claim 15, wherein the driving transistor, the first transistor and the second transistor are N-type transistors, and the third transistor is a P-type transistor.

17. The display device of claim 15, wherein the first transistor and the second transistor are P-type transistors, and the third transistor and the driving transistor are N-type transistors.

18. The display device of claim 15, wherein the light emitting control module further comprises an inverter, having an input end receiving the scan signal and an output end electrically connected to the gate of the third transistor.

19. The display device of claim 18, wherein the driving transistor, the first transistor, the second transistor and the third transistor are a same type of transistors.

20. The display device of claim 11, wherein the scan signal, the first control signal and the second control signal are used to control the display panel to operate in a data write-in phase and a light emitting phase.
